(19) United States
(12) Patent Application Publication
(10) Pub. No.: US 2014/0298164 A1
(43) Pub. Date: Oct. 2, 2014

(54) ELECTRONIC BOOK PRODUCTION APPARATUS, ELECTRONIC BOOK SYSTEM, ELECTRONIC BOOK PRODUCTION METHOD, AND NON-TRANSITORY COMPUTER-READABLE MEDIUM

(71) Applicant: FUJIFILM Corporation, Tokyo (JP)

(72) Inventors: Hajime Terayoko, Tokyo (JP); Erina Ogura, Tokyo (JP)

(73) Assignee: FUJIFILM Corporation, Tokyo (JP)

(21) Appl. No.: 14/227,685

(22) Filed: Mar. 27, 2014

(30) Foreign Application Priority Data
Mar. 29, 2013 (JP) 2013-073106

(51) Int. Cl. G06F 17/21; G06F 17/30

(52) U.S. Cl. CPC G06F 17/211; G06F 17/30634
USPC 715/243

(57) ABSTRACT

An electronic book production apparatus includes; an image obtaining unit; a character area detecting unit; a character recognizing unit; a character position information obtaining unit; a reading-order determining unit which determines a reading order among the character areas in the page image based on positions of the character areas in the page image and continuity from a character to another character between the character areas in the page image; an electronic book data generating unit which generates electronic book data including character information indicating the recognized characters, the character position information indicating the position of each of the recognized characters in the page image, and order information about the characters or the character areas corresponding to the reading order among the character areas in the page image; and an electronic book data output unit which outputs the electronic book data generated by the electronic book data generating unit.

### BACKGROUND OF THE INVENTION

1. Field of the Invention

The present invention relates to an electronic book production apparatus, electronic book system, electronic book production method, and computer-readable medium allowing an easy search for a character string across a plurality of character areas in a page image when the page image including the character areas is displayed on an electronic book viewer device without a layout change.

2. Description of the Related Art

Conventionally, a technology has been known which allows an electronic book to be distributed via a network or obtained via a portable recording medium (memory card) and displayed on a portable terminal

Japanese Unexamined Patent Application Publication No. 2012-133659 discloses that an image per page unit (a page image) on an electronic book is analyzed and auxiliary information including balloon information (such as a balloon area), text information (such as lines in a balloon), and display control information (such as a reading order in a page image) is generated to generate electronic book data including the page image and the auxiliary information.

Japanese Unexamined Patent Application Publication No. 2004-240643 discloses that a reading order in a character area is first preliminarily determined correspondingly to vertical writing or horizontal writing and then continuity of characters between character areas is determined to change the reading order to a final reading order.

### SUMMARY OF THE INVENTION

However, if the layout in the page image of the electronic book is complex, it is disadvantageously difficult to conduct a full-text search of character strings on a viewer device.

Among electronic books, hybrid electronic books placed between electronic books with characters and electronic books mainly with images are difficult to handle. Hybrid electronic books generally have many diagrams and tables, and include characters in a complex layout. In such a hybrid electronic book, it is desired to achieve layout reproduction and also allow a search of all character strings in a page image (a full-text search). In particular, for example, when a character area and a non-character area are arranged in complex combination in a page image, it is difficult to conduct an operation of searching for a character string across a plurality of character areas in a page image.

In Japanese Unexamined Patent Application Publication No. 2012-133659, information indicating the reading order in a page image is generated and annexed to the page image. However, this patent gazette discloses neither a specific reading-order determining method nor an operation of searching for a character string across a plurality of character areas in a page image.

In Japanese Unexamined Patent Application Publication No. 2004-240643, a method of determining a reading order in a character area is disclosed. However, this patent gazette does not disclose a capability of a search for a character string across a plurality of character areas in a page image.

The present invention was made in view of these circumstances. An object of the present invention is to allow a full-text search while a complex layout is completely reproduced. In particular, an object of the present invention is to allow an easy search for a character string across a plurality of character areas in a page image when the page image including the character areas is displayed on an electronic book viewer device without a layout change.

To achieve the objects described above, the present invention provides an electronic book production apparatus including an image obtaining unit which obtains a page image representing an image per page unit where character areas and non-character areas are arranged, a character area detecting unit which detects the character areas in the page image obtained by the image obtaining unit, a character recognizing unit which recognizes characters in the character areas detected by the character area detecting unit, a character position information obtaining unit which obtains, for each of the characters recognized in the character areas, character position information indicating a position of the recognized character in the page image, a reading-order determining unit which determines a reading order among the character areas in the page image based on positions of the character areas in the page image and continuity from a character to another character between the character areas in the page image, an electronic book data generating unit which generates electronic book data including character information indicating the recognized characters, the character position information indicating the position of each of the recognized characters in the page image, and order information about the characters or the character areas corresponding to the reading order among the character areas in the page image, and an electronic book data output unit which outputs the electronic book data generated by the electronic book data generating unit.

According to the present invention, the reading order among the character areas in the page image is determined based not only on the position of the character areas in the page image but also on continuity from character to character between the character areas. Also, electronic book data is generated, including character information indicating the recognized characters, character position information indicating the position of each character recognized in the page image, and order information about the characters or the character areas corresponding to the reading order among the character areas in the page image. Therefore, an easy search can be made for a character string across a plurality of character areas in a page image when the page image with a complex layout is displayed without a layout change at a viewer device obtaining the electronic book.

According to an aspect of the present invention, the apparatus further includes a display control program generating unit which generates a display control program to be executed by a viewer device capable of displaying the page image, the display control program having a search function capable of searching for a character string across character areas in the page image and a highlight display function capable of highlighting the character string across the character areas found by the search, based on information added to the page image in the electronic book data, wherein the electronic book data generating unit incorporates the display control program into the electronic book data. According to this aspect, the display control program having the search function capable of searching for a character string across character areas in the page image and the highlight display function capable of highlighting the character string across the character areas found by the search is incorporated in the electronic book data. Therefore, an easy search for a character string across a plurality of character areas in the page image can be made even without preparing a special search function on a viewer device side.

According to another aspect of the present invention, the display control program generating unit generates the display control program that has a function of switching by the viewer device between a first display mode of displaying the page image without changing an arrangement of the character areas and the non-character areas and an arrangement of the characters in the character areas and a second display mode of reflow display of the characters in the character areas. According to this aspect, it is possible for the user to select between the first display mode without a layout change and the second display mode of reflow display by changing the layout, even without preparing a special search function on a viewer device side.

According to still another aspect of the present invention, the reading-order determining unit preliminarily determines a reading order among the character areas based on the positions of the character areas in the page image, and corrects the reading order among the character areas in the page image based on the continuity from one character to another character between the character areas in the page image. According to this aspect, the reading order among the character areas can be quickly and reliably determined.

According to still another aspect of the present invention, the apparatus further includes a table-of-contents information generating unit which generates table-of-contents information indicating a correspondence between a title and a page number for every page or every plurality of pages for the page image, wherein the electronic book data generating unit incorporates the table-of-contents information into the electronic book data. According to this aspect, a page image desired by the user can be easily displayed on the viewer device based on the table-of-contents information.

According to still another aspect of the present invention, the apparatus further includes an index information generating unit which generates index information indicating a correspondence between a character string in the character area in the page image and a page number, wherein the electronic book data generating unit incorporates the index information into the electronic book data. According to this aspect, a page image desired by the user can be easily displayed on the viewer device based on the index information.

According to still another aspect of the present invention, the apparatus further includes an anchor setting unit which sets, to a character indicating a partial image in any of the non-character areas among the characters in the character areas in the page image, an anchor for switching display to the partial image in the non-character area. According to this aspect, the user can easily view the character information in the character area and the partial image in the non-character area in association with each other.

According to still another aspect of the present invention, the apparatus further includes a translation information generating unit which generates translation information obtained by translating character information indicating the characters recognized by the character recognizing unit into a language different from a language of the character information, wherein the electronic book data generating unit incorporates the translation information into the electronic book data. According to this aspect, it is possible for the user to easily understand even an electronic book in a language which is not a mother tongue of the user.

Also, the present invention provides an electronic book system including any of the electronic book production apparatuses described above and a viewer device which obtains the electronic book data outputted from the electronic book production apparatus and displays the page image in the electronic book data.

According to still another aspect of the present invention, the viewer device has a search function capable of searching for a character string across character areas and a in the page image and a highlight display function capable of highlighting the character string found by the search, based on information added to the page image in the electronic book data. According to this aspect, by using the search function and the highlight display function prepared on a viewer device side, a character string across a plurality of character areas can be searched for and displayed.

According to still another aspect of the present invention, the viewer device has a function of switching by the viewer device between a first display mode of displaying the page image without changing an arrangement of the character areas and characters in the character areas and a second display mode of reflow display by changing the arrangement of the characters in the character area. According to this aspect, by using the switching function prepared on a viewer device side, switching can be made by the viewer device between the first display mode (page image full display) and the second display mode (reflow display).

The present invention provides an electronic book production method including an image obtaining step of obtaining a page image representing an image per page unit where character areas and non-character areas are arranged, a character area detecting step of detecting the character areas in the page image obtained in the image obtaining step, a character recognizing step of recognizing characters in the character areas detected in the character area detecting step, a character position information obtaining step of obtaining, for each of the characters recognized in the character areas, character position information indicating a position of the recognized character in the page image, a reading-order determining step of determining a reading order among the character areas in the page image based on positions of the character areas in the page image and continuity from character to character between the character areas in the page image, an electronic book data generating step of generating electronic book data including character information indicating the recognized characters, the character position information indicating the position of each of the recognized characters in the page image, and order information about the characters or the character areas corresponding to the reading order among the character areas in the page image, and an electronic book data output step of outputting the electronic book data generated in the electronic book data generating step.

Also, the present invention provides a non-transitory computer-readable medium storing a program causing a computer to perform steps including an image obtaining step of obtaining a page image representing an image per page unit where character areas and non-character areas are arranged, a character area detecting step of detecting the character areas in the page image obtained in the image obtaining step, a character recognizing step of recognizing characters in the character areas detected in the character area detecting step, a character position information obtaining step of obtaining, for each of the characters recognized in the character areas, character position information indicating a position of the recognized character in the page image, a reading-order determining step of determining a reading order among the character areas in the page image based on positions of the character areas in the page image and continuity from character to character between the character areas in the page image, an electronic book data generating step of generating electronic book data including the page image, the character information indicating the recognized characters, the character position information indicating the position of each of the recognized characters in the page image, and order information about the characters or the character areas corresponding to the reading order among the character areas in the page image, and an electronic book data output step of outputting the electronic book data generated in the electronic book data generating step.

According to the present invention, it is possible to allow an easy search for a character string across a plurality of character areas in a page image when the page image including the character areas is displayed on an electronic book viewer device without a layout change.

### BRIEF DESCRIPTION OF THE DRAWINGS

FIG. 1 is an entire structure diagram of an example of an electronic book system;

FIG. 2 is a hardware structure diagram of an example of an electronic book production apparatus;

FIG. 3 is a descriptive diagram for use in describing a relation between an electronic book production program and various information;

FIG. 4 is a functional block diagram of an example of the electronic book production apparatus;

FIG. 5 is a hardware structure diagram of an example of a viewer device;

FIG. 6 is a flowchart depicting a flow of an example of an electronic book production process;

FIG. 7 is a descriptive diagram of an example of an obtained page image;

FIG. 8 is a descriptive diagram of a character area detected from the page image of FIG. 7;

FIG. 9 is a descriptive diagram for use in describing character position information indicating the position of a character recognized in the page image of FIG. 7;

FIG. 10 is a descriptive diagram for use in describing a first reading-order determination result;

FIG. 11 is a descriptive diagram for use in describing a second reading-order determination result;

FIG. 12 is a descriptive diagram of an example of full display of a page image on a viewer device;

FIG. 13 is a descriptive diagram of an enlarged main part of the page image of FIG. 12;

FIG. 14 is a descriptive diagram of an example of reflow display on the viewer device; and

FIG. 15 is a descriptive diagram of an example of hyperlink display on the viewer device.

### DETAILED DESCRIPTION OF THE PREFERRED EMBODIMENTS

Embodiments of the present invention are described in detail below with reference to the attached drawings.

<System Structure>

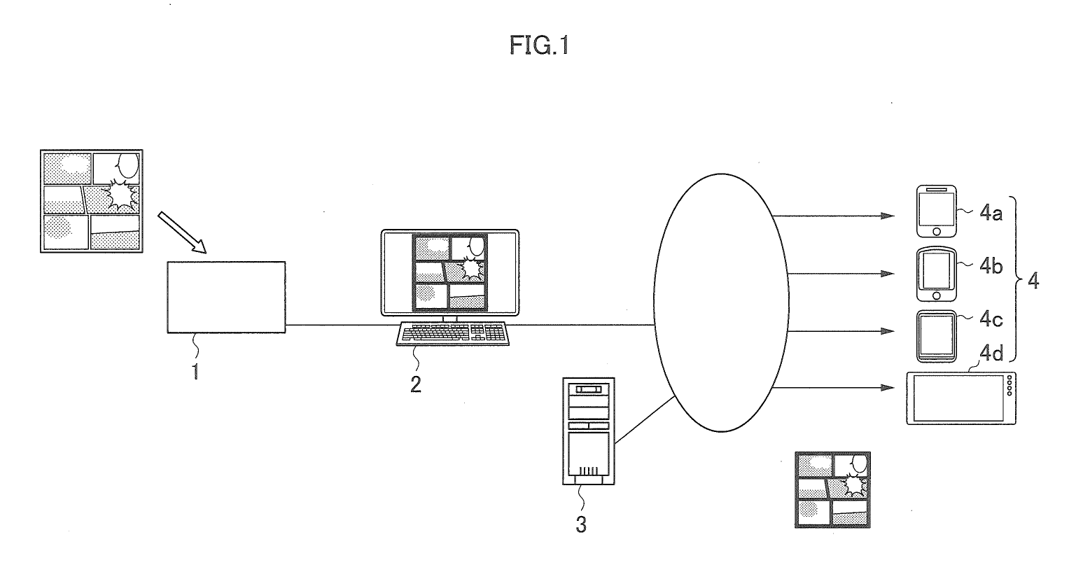

FIG. 1 is an entire structure diagram of an example of an electronic book system (an electronic book data distribution system).

A scanner 1 reads a book draft on paper to generate an image per page unit where character areas and non-character areas are arranged (hereinafter referred to as a “page image”). While FIG. 1 depicts an example in which a paper-medium book draft is read by the scanner 1 to obtain a page image on one or plurality of pages, the present invention is not meant to be restricted to this example. An electronically-generated book draft (digital draft) may be inputted via a network or a recording medium to obtain a page image on one or plurality of pages.

An electronic book production apparatus 2 is an apparatus which generates electronic book data including a page image on one or plurality of pages (hereinafter also simply referred to as an “electronic book). The electronic book production apparatus 2 is configured of, for example, a computer apparatus.

A server apparatus 3 transmits the electronic book data generated by the electronic book production apparatus 2 via a network to a viewer device 4, upon a distribution request from the viewer device 4. The server apparatus 3 is configured of, for example, a computer apparatus.

The viewer device 4 (4a, 4b, 4c, 4d) receives the electronic book data transmitted from the server apparatus 3 and displays the page image. The viewer device 4 is any of various portable terminals such as portable telephones, smartphone, and tablet terminals or any of various terminal devices (computer apparatuses) such as personal computers.

The viewer device 4 has a display screen, and the size of the display screen varies for each model. When the display screen size of the viewer device 4 is smaller than the display size of an entire page image per page unit of the electronic book data, display is made as a display area corresponding to the display screen size of the viewer device 4 is sequentially moved in the page image per page unit. As such, with a display area corresponding to the display screen size being moved in the page image, a partial image in a display range is sequentially displayed on the display screen of the viewer device 4, which may be referred to as “trace display” or “sequential display”.

<Components of Electronic Book Production Apparatus>

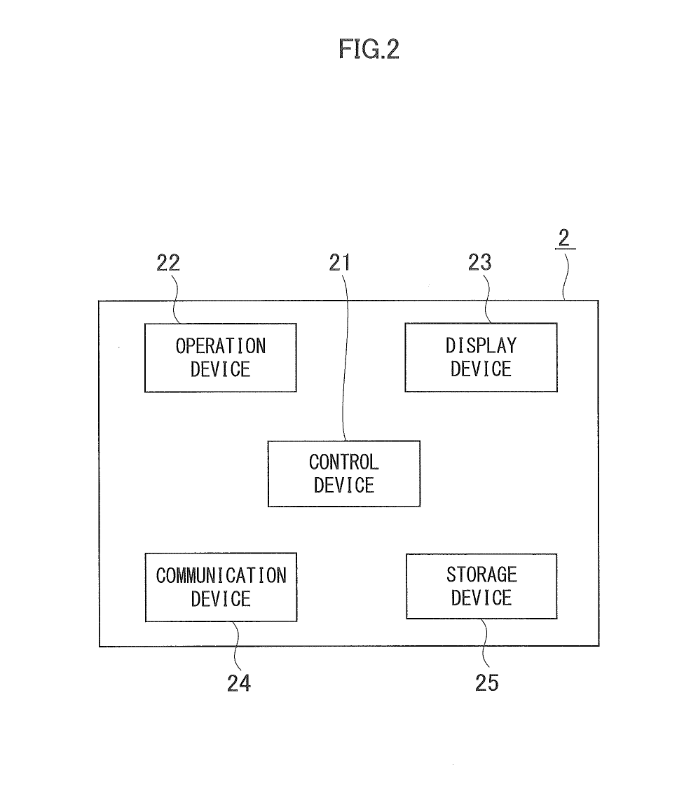

FIG. 2 is a hardware structure diagram of an example of the electronic book production apparatus 2. As depicted in FIG. 2, the electronic book production apparatus 2 of the present example is configured of a computer apparatus including a control device 21, an operation device 22, a display device 23, a communication device 24, and a storage device 25. The control device 21 is configured of, for example, a CPU (Central Processing Unit). The CPU may be hereinafter referred to as a “microcomputer”. The operation device 22 is configured of, for example, a keyboard and a mouse. The display device 23 is configured of, for example, a liquid-crystal display device. The communication device 24 is a device that can make communication with the server apparatus 3 via a network. The storage device 25 is configured of, for example, a large-capacity disk such as a hard disk.

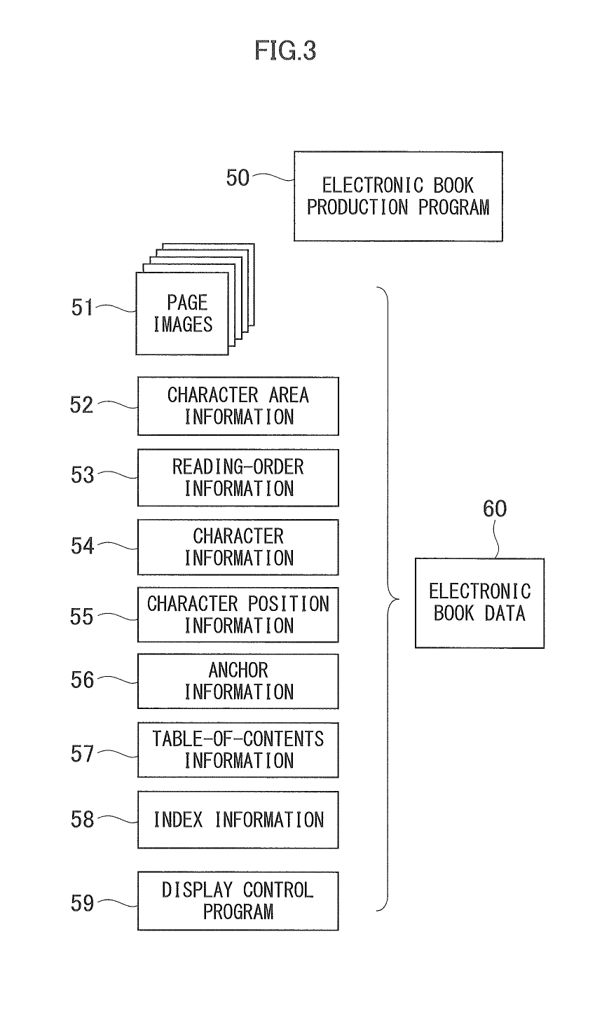

As depicted in FIG. 3, the control device 21 of the electronic book production apparatus 2 executes an electronic book production program 50, associating page images 51 with auxiliary information such as character area information 52, reading-order information 53, character information 54, character position information 55, anchor information 56, table-of-contents information 57, and index information 58 to generate electronic document data 60 of an EPUB (Electronic PUBlication) format published by IDPF (International Digital Publishing Forum). Also, a display control program 59 may be added to the page images 51. In this case, other additional information (for example, the character area information 52, the reading-order information 53, the character information 54, the character position information 55, the anchor information 56, the table-of-contents information 57, and the index information 58) may be included in the display control program 59. Each of these pieces of additional information will be described in detail further below.

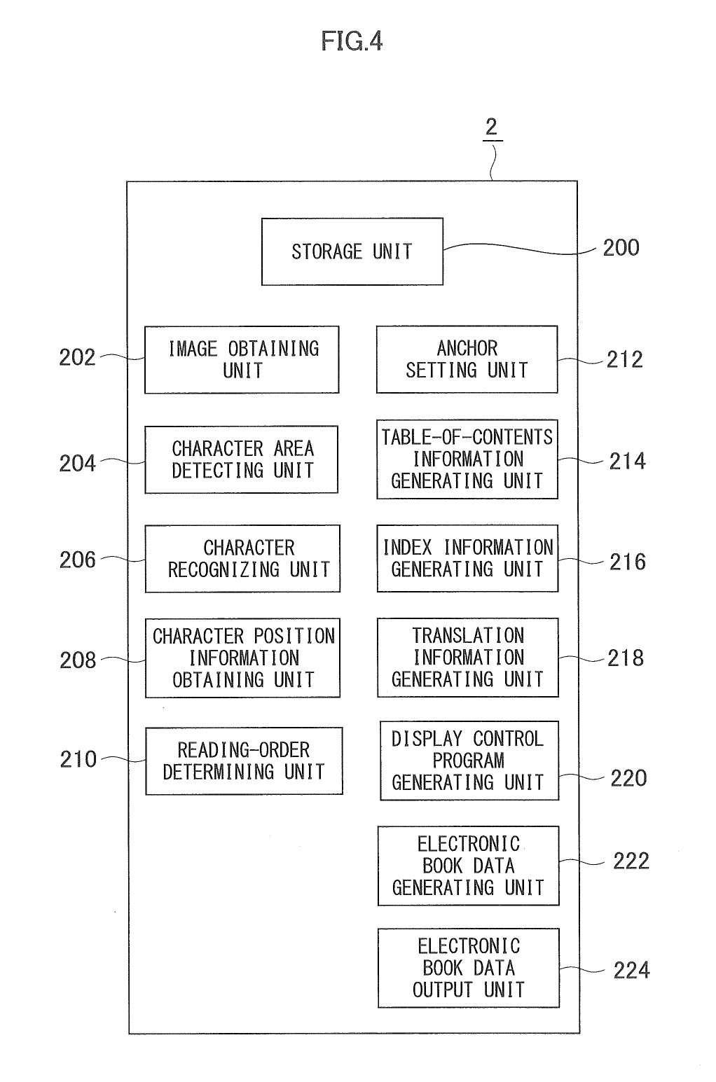

FIG. 4 is a functional block diagram of an example of the electronic book production apparatus 2.

The electronic book production apparatus 2 of this example is configured to include a storage unit 200, an image obtaining unit 202, a character area detecting unit 204, a character recognizing unit 206, a character position information obtaining unit 208, a reading-order determining unit 210, an anchor setting unit 212, a table-of-contents information generating unit 214, an index information generating unit 216, a translation information generating unit 218, a display control program generating unit 220, an electronic book data generating unit 222, and an electronic book data output unit 224. The storage unit 200 is configured of, for example, the storage device 25 of FIG. 2. The image obtaining unit 202 is configured of, for example, the communication device 24 of FIG. 2. The character area detecting unit 204, the character recognizing unit 206, the character position information obtaining unit 208, the reading-order determining unit 210, the anchor setting unit 212, the table-of-contents information generating unit 214, the index information generating unit 216, the translation information generating unit 218, the display control program generating unit 220, and the electronic book data generating unit 222 are configured of, for example, the control device 21 of FIG. 2. The electronic book data output unit 224 is configured of, for example, the communication device 24 of FIG. 2.

The storage unit 200 stores various information such as the page images 51, the character area information 52, the reading-order information 53, the character information 54, the character position information 55, the anchor information 56, the table-of-contents information 57, the index information 58, and the display control program 59.

The image obtaining unit 202 obtains any of the page images 51 representing images per page unit where a character area and a non-character area are arranged, the page image 51 to be incorporated in the electronic book data 60 (electronic book). Here, the page unit is not restricted to a one-page unit but may be a unit of a plurality of pages (for example, a two-page unit). Examples of the page image 51 include images read from paper such as newspaper, magazine, comic (cartoon), office document, textbook, and reference book. The page image 51 may be a page image electronically generated from scratch. For example, one or plurality of page images 51 read from a paper medium by the scanner 1 of FIG. 1 are obtained. One or plurality of page images 51 may be obtained from the server apparatus 3.

The character area detecting unit 204 detects a character area in the page image 51 obtained by the image obtaining unit 202, and outputs the character area information 52. Detection of a character area can be performed by using any of various known technologies.

The character recognizing unit 206 recognizes a character in the character area detected by the character area detecting unit 204, and outputs the character information 54. Character recognition can be performed by using any of various known technologies.

For each character recognized in any character area, the character position info nation obtaining unit 208 obtains the character position information 55 indicating the position of the character recognized in the page image 51. An example of the character position information 55 will be described further below.

The reading-order determining unit 210 determines a reading order among the character areas in the page image 51 based on the positions of the character areas in the page image 51 and continuity from character to character between the character area in the page image 51, and outputs the reading-order information 53. Reading-order determination based on the positions of the character areas is performed by determining vertical and horizontal positional relation among the character areas based on, for example, language of the characters, vertical writing/horizontal writing, etc. Reading-order determination based on continuity from character to character is performed based on whether characters are continuous between character areas as a word, by using a word dictionary, language processing such as language analysis (for example, morphological analysis), etc.

To a character (for example, a diagram or table number) indicating a partial image (for example, a diagram or table) in a non-character area among characters in the character areas in the page image 51, the anchor setting unit 212 sets an anchor for switching display to the partial image (for example, diagram or table) in that non-character area. That is, into a character string in a character area, the anchor setting unit 212 inserts the anchor information 56 (for example, a hyperlink) for switching to the partial image in the non-character area.

The table-of-contents information generating unit 214 generates the table-of-contents information 57 indicating a correspondence between a title (a chapter title) and a page number for every page or every plurality of pages regarding the page image 51.

The index information generating unit 216 generates the index information 58 indicating a correspondence between a character string (a keyword candidate) in a character area of the page image 51 and a page number.

The translation information generating unit 218 translates character information indicating characters recognized by the character recognizing unit 206 into a language (for example, English) different from the language of the recognized character information (for example, Japanese) to generate translation information.

The display control program generating unit 220 generates the display control program 59 to be executed by the viewer device 4 that can display the page image 51. For example, the display control program 59 is generated with a script language such as JavaScript (registered trademark). Any other language may be used. The display control program 59 of this example has a search function capable of searching for a character string (a search word) in a character area and a character string (a search word) across character areas in the page image 51 based on the information (such as the character information 54, the character position information 55, the reading-order information 53) added to the page image 51 in the electronic book data 60 and a display function capable of highlighting the character string found by the search. Also, the display control program 59 of this example has a function of switching by the viewer device 4 between a display mode (a first display mode) of full display for displaying the page image without changing the arrangement of character areas, non-character areas, and characters in the character areas and a display mode (a second display mode) of reflow display of the characters in the character areas.

The electronic book data generating unit 222 generates the electronic book data 60 by associating various information with the page image 51. The electronic book data generating unit 222 generates the electronic book data 60 by associating at least the character information 54 indicating the recognized character, the character position information 55 indicating the position of the character recognized in the page image 51, and the reading-order information 53 including character order information (or character-area order information) corresponding to the reading order among character areas in the page image 51 with the page image 51. As depicted in FIG. 3, the character area information 52, the reading-order information 53, the character information 54, the character position information 55, the anchor information 56, the table-of-contents information 57, and the index information 58 may be added to the page image 51. Furthermore, the translation information may be added. Still further, the display control program 59 may be added to the page image 51.

The electronic book data output unit 224 outputs the electronic book data 60 generated by the electronic book data generating unit 222.

<Viewer Device>

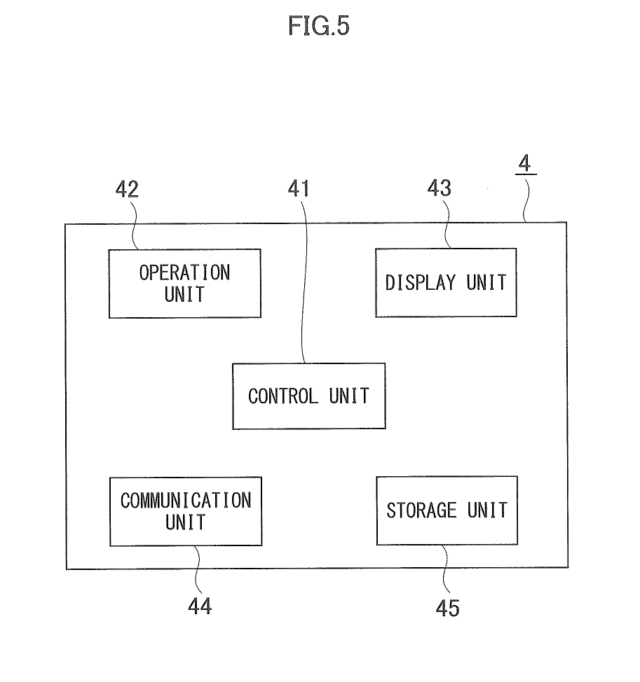

FIG. 5 depicts an example of hardware structure of the viewer device 4 for viewing the electronic book data 60 generated by the electronic book production apparatus 2. The viewer device 4 of this example is configured of a portable terminal including a control unit 41, an operation unit 42, a display unit 43, a communication unit 44, and a storage unit 45. The control unit 41 is configured of, for example, a CPU (Central Processing Unit). The control unit 42 and the display unit 43 are configured of, for example, a touch panel display. The communication unit 44 is a device communicable with the server device 3 via a network. The storage unit 45 is configured of, for example, a memory.

The communication unit 44 issues 3 a request for distributing the electronic book data 60 to the server device, and receives the electronic book data 60 from the server device 3.

The control unit 41 executes a viewer program stored in the storage unit 45 by following an instruction inputted from a user to the operation unit 42.

The control unit 41 also follows the display control program 59 incorporated in the electronic book data 60 to perform display control of the page image 51 incorporated in the electronic book data 60, and causes the page image 51 to be displayed on the display unit 43.

<General Outline of Electronic Book Production Process>

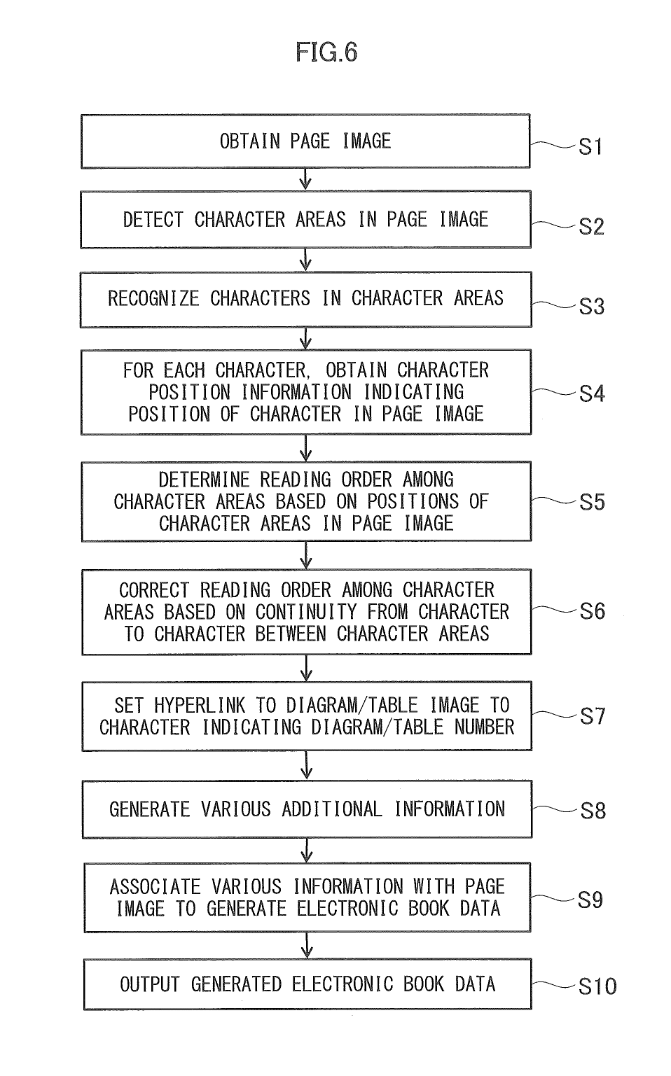

FIG. 6 is a flowchart depicting a flow of an example of an electronic book production process. The process is performed by following a program under the control of the control device 21 (microcomputer) of FIG. 2. The program can be stored in advance in a recording medium electrically, magnetically, or by using another known method, and can be read from that recording medium.

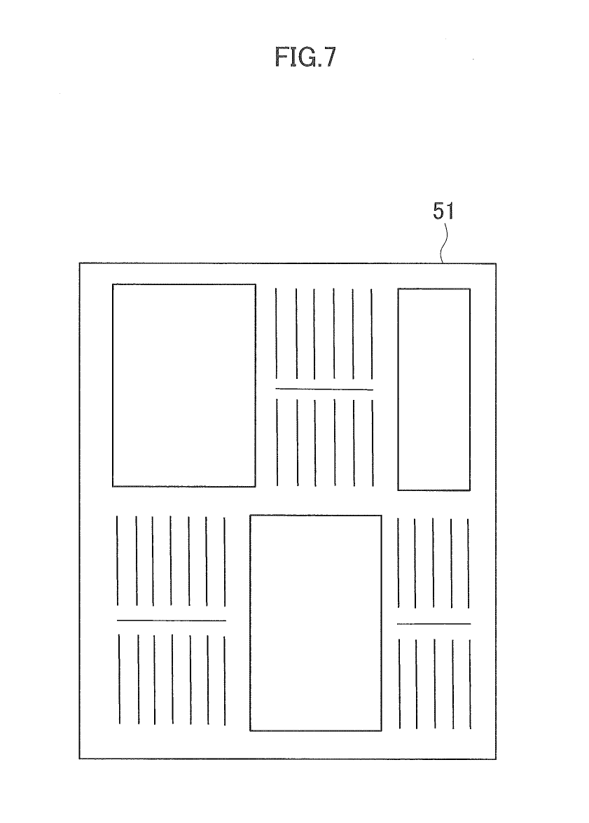

First, the page image 51, which is an image per page unit where character areas and non-character areas are arranged, is obtained by the image obtaining unit 202 (step S1). FIG. 7 depicts an example of the obtained page image 51.

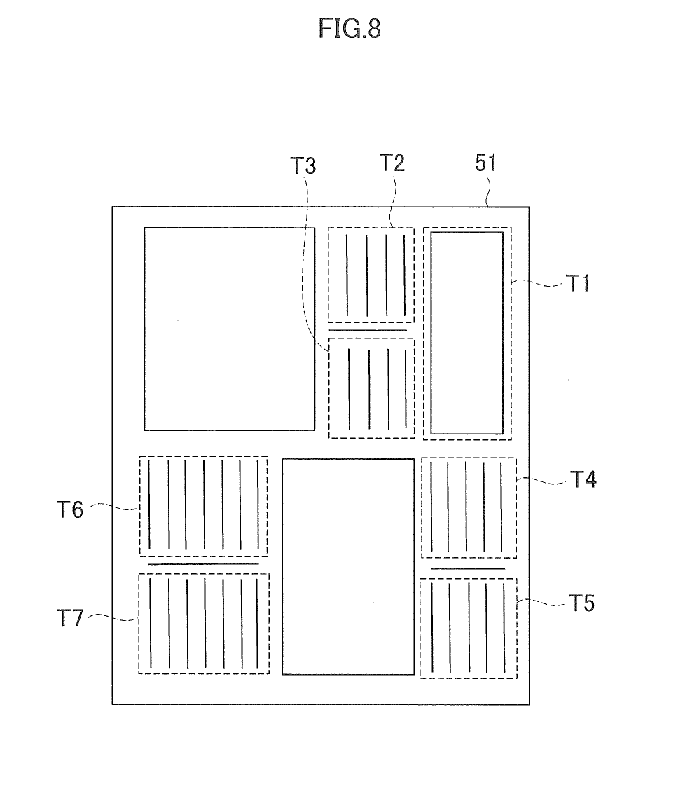

Next, the character areas are detected by the character area detecting unit 204 in the obtained page image 51 (step S2). Here, the character area information 52 is generated by the character area detecting unit 204. FIG. 8 depicts character areas T1, T2, T3, T4, T5, T6 and T7 detected in the page image 51 of FIG. 7.

Next, characters in the detected character areas T1 to T7 are recognized by the character recognizing unit 206 (step S3). Here, the character information 54 is generated by the character recognizing unit 206.

Next, for each character recognized in the character areas T1 to T7, character position information indicating the position (coordinates) of the character recognized in the page image 51 is obtained (step S4). Here, the character position information 55 is generated by the character position obtaining unit 208.

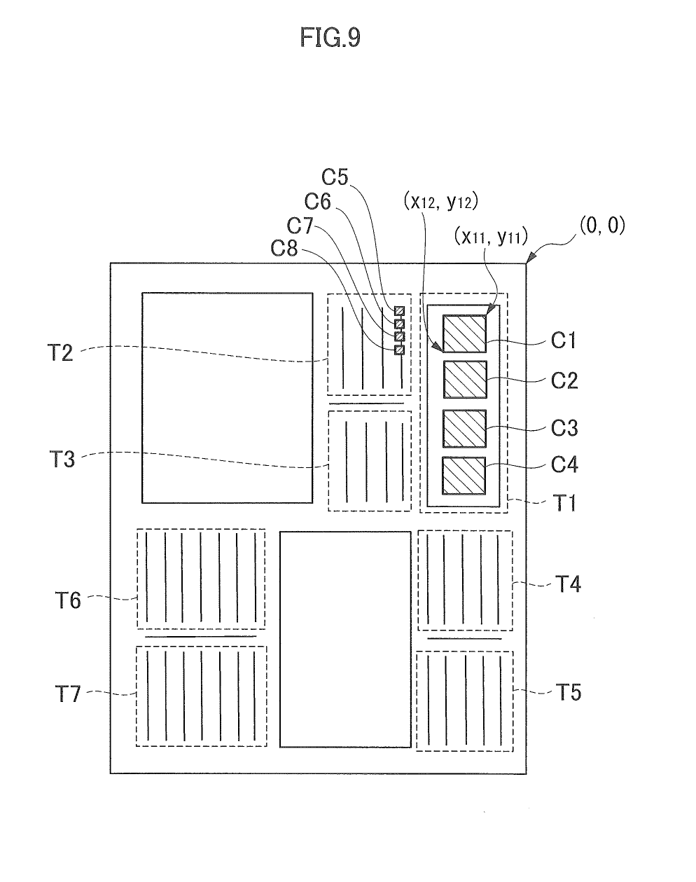

FIG. 9 depicts an example of the position of each character recognized in the page image 51 of FIG. 7. In the example depicted in FIG. 9, four characters C1, C2, C3, and C4 have been recognized by the character recognizing unit 206 in the character area T1. Also, for each of the characters C1, C2, C3, and C4 recognized in the character area T1, coordinates of two points (in this example, an upper-right end and a lower-left end) on a diagonal line of a rectangle surrounding the character in the page image are calculated by the character recognizing unit 206 as character position information (for example, (x₁₁, y₁₁) and (x₁₂, y₁₂) regarding the character C1). In this example, the upper-right end of the page image is taken as the origin (0, 0), and a horizontal direction in the drawing is taken as an x direction and a vertical direction in the drawing is taken as a y direction. As with the characters C1 to C4 in the character area T1, for each of characters (C5, C6, C7, C8, . . . ) recognized in the character area T2, coordinates of two points on a diagonal line of a rectangle surrounding the character in the page image are calculated as character position information. Similarly, in other character areas T3 to T7, character position information is calculated.

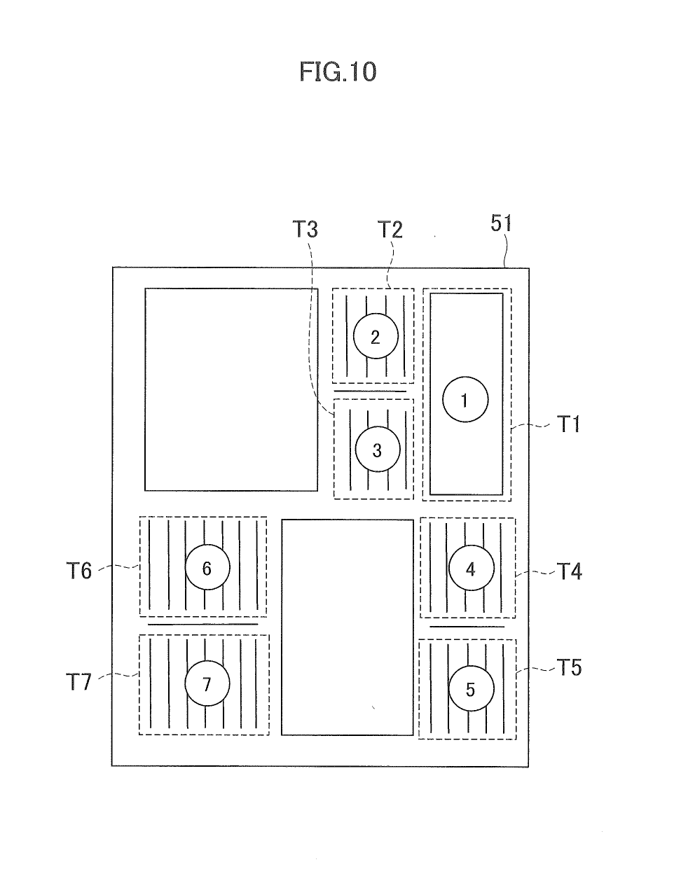

Next, as a first reading-order determination, a reading order among the character areas in the page image 51 is determined by the reading-order determining unit 210 based on the position of each character area in the page image 51 (step S5). FIG. 10 depicts a first reading-order determination result in the page image 51 of FIG. 7. In the page image 51 of this example, since characters are in Japanese and are written vertically, a reading order is preliminarily determined basically in the order from right to left and from up to down. That is, the reading order is preliminarily determined as T1→T2→T3→T4→T5→T6→T7.

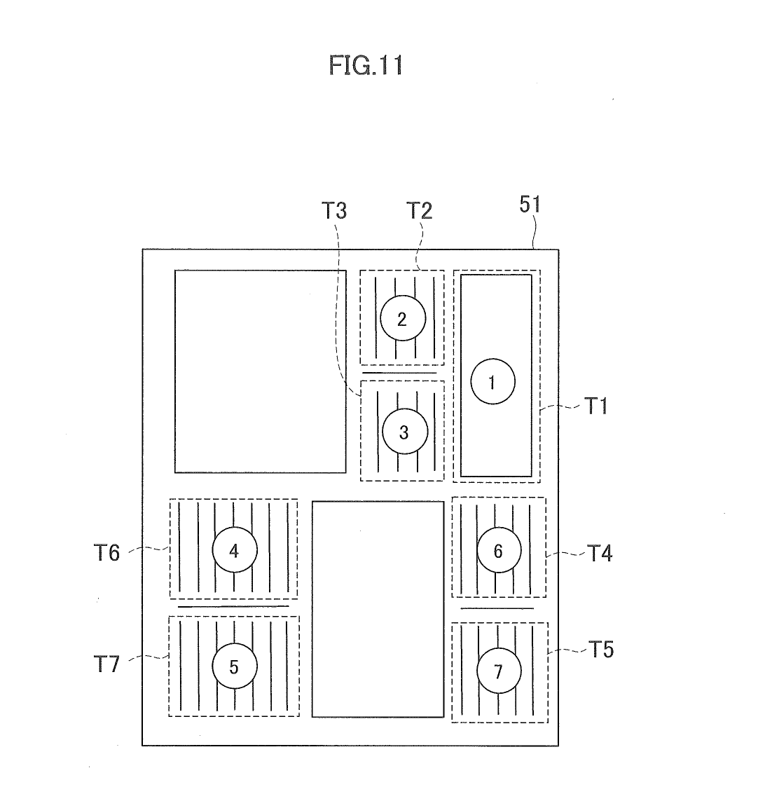

Next, as a second reading-order determination, a reading order among the character areas in the page image 51 is determined by the reading-order determining unit 210 based on continuity between characters between character areas in the page image 51 (Step S6). FIG. 11 depicts a second reading-order determination result in the page image 51 of FIG. 7. In this example, it is determined whether continuity from character to character between character areas is achieved in the reading order preliminarily determined at step S5. In the page image 51 of this example, the character at the end of the character area T3 and the character at the head of the character area T4 do not have linguistic continuity, the character at the end of the character area T3 and the character at the head of the character area T6 have linguistic continuity, and the character at the end of the character area T6 and the character at the head of the character area T7 have linguistic continuity. Therefore, the character area T3 is followed by the character area T6 and the character area T6 is followed by the character area T7, and the reading order is thus changed from T1→T2→T3→T4→T5→T6→T7 to T1→T2→T3→T6→T7→T4→T5.

The reading-order information 53 is generated by the reading-order determining unit 210. In this example, not only the reading order in the character areas of T1→T2→T3→T4→T5→T6→T7 (character area order information) but also information indicating a character reading order in the page image 51 (character order information) is generated. Either one of the character order information and the character area order information may be generated.

Next, among the characters in the character areas of the page image 51, a hyperlink to an image of a diagram or table (hereinafter referred to as a “diagram/table image”) in each non-character area is set by the anchor setting unit 212 to a character indicating a number (a diagram/table number) of the diagram/table image in the non-character area (step S7). Here, the anchor information 56 is generated by the anchor setting unit 212. For example, when a character “Fig. A” indicating a diagram/table number of “Fig. A” of a diagram or table in a non-character area is present in the character area, a hyperlink to the diagram/table image in the non-character area is set as “Fig. A”.

Next, various additional information to be added to the page image are generated (step S8). In this step S8, various additional information other than the additional information generated at steps S2 to S7 are generated. In this example, the table-of-contents information 57 indicating the correspondence between the title (the chapter title) and the page number for every page or every plurality of pages regarding the page image is generated by the table-of-contents information generating unit 214. Also, the index information 58 indicating the correspondence between the keyword and the page number is generated by the index information generating unit 216. Also, the translation information is generated by the translation information generating unit 218 translating the character information indicating the characters recognized by the character recognizing unit 206 into a language (in this example, English) different from the language of the character information (in this example, Japanese). Furthermore, the display control program 59 to be executed by the viewer device 4 is generated by the display control program generating unit 220. Still further, when the character position information obtained by the character position information obtaining unit 208 and the reading-order information determined by the reading-order determining unit 210 are not in a required format, the character position information and the reading-order information are edited. In this example, character-associated information is generated for each character, including a character ID (character identification information), character position information (coordinates on the page image), character information (for example, “temple”), and character order information. For example, information such as <char id=“1”, rect=“20, 20, 100, 100”, text=“temple”, order=“1”/> is generated. This character-associated information corresponds to the character information 54 of FIG. 3, the character position information 55, and the reading-order information 53. Also in this example, the character order information in the page image is incorporated in the electronic book data 60. Alternatively, the character area information 52 indicating character areas and the character area order information may be incorporated in the electronic book data 60.

Next, various additional information generated at steps S2 to S8 and the page image 51 are associated with each other by the electronic book data generating unit 222 to generate the electronic book data 60 (step S9). For example, the character area information 52 generated by the character area detecting unit 204 and the reading-order information 53 including the character area order information and the character order information generated by the reading-order determining unit 210, the character information 54 generated by the character recognizing unit 206, the character position information 55 generated by the character position information obtaining unit 208, the anchor information 56 generated by the anchor setting unit 212, the table-of-contents information 57 generated by the table-of-contents information generating unit 214, the index information 58 generated by the index information generating unit 216, and the display control program 59 generated by the display control program generating unit 220 are added to the page image 51 as additional information to generate the electronic book data 60. In this example, the character associated information generated at step S8 is incorporated in the electronic book data 60.

Next, the generated electronic book data 60 is outputted by the electronic book data output unit 224 (step S 10).

<General Outline of Viewing Process at Viewer Device>

Description is made to the case in which the electronic book data 60 is viewed at the viewer device 4 depicted in FIG. 5. First, the electronic book data 60 is obtained from the server device 3 by the communication unit 44 of the viewer device 4. The electronic book data 60 may be obtained from a removable recording medium. When the display control program 59 is packaged in the electronic book data 60, the control unit 41 of the viewer device 4 extracts the display control program 59 from the electronic book data 60, and performs display control of the page image 51 by following the display control program 59.

When the display control program 59 is started by operation of the operation unit 42, the control unit 41 causes display of the entire page image 51 depicted in FIG. 7.

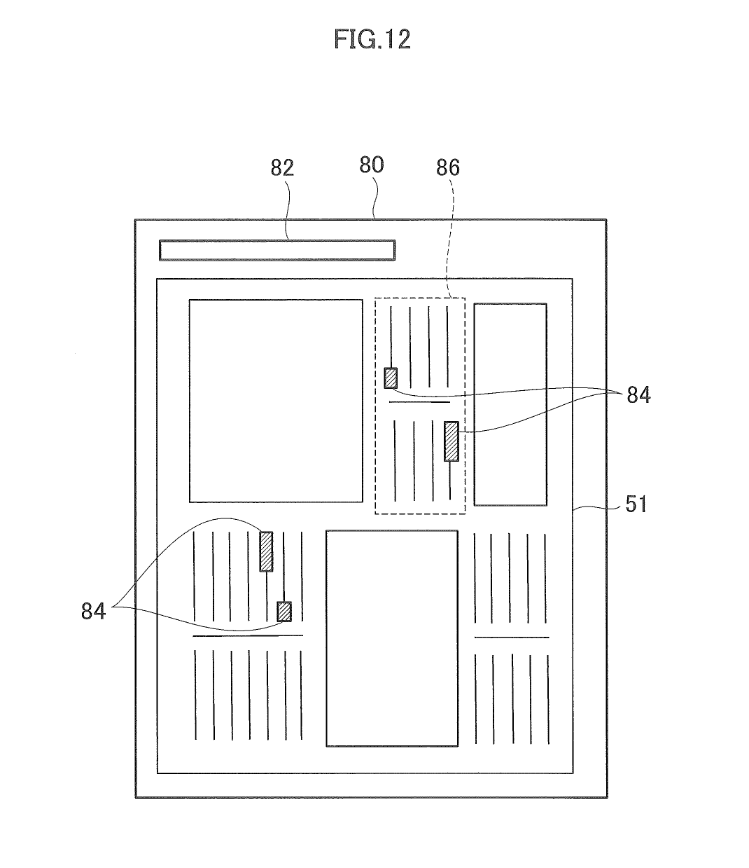

FIG. 12 depicts an electronic book viewing window 80 displayed on the display unit 43 of the viewer device 4 under the control of the control unit 41. The electronic book viewing window 80 in this example is provided with a search word input frame 82.

When a search word is inputted to the search word input frame 82 by operation of the operation unit 42, the control unit 41 causes highlight display of a search word 84 (a character string in a character area corresponding to the search word input frame 82) in any of the character areas of the page image 51. Here, highlight display refers to display with characters configuring a search word in a character area highlighted in a mode different from the mode to be applied to other characters. There are various highlight modes, for example, displaying the characters with a color different from colors of the other characters, displaying the characters more brightly than the other characters, providing gradation, displaying a frame around the characters, etc.

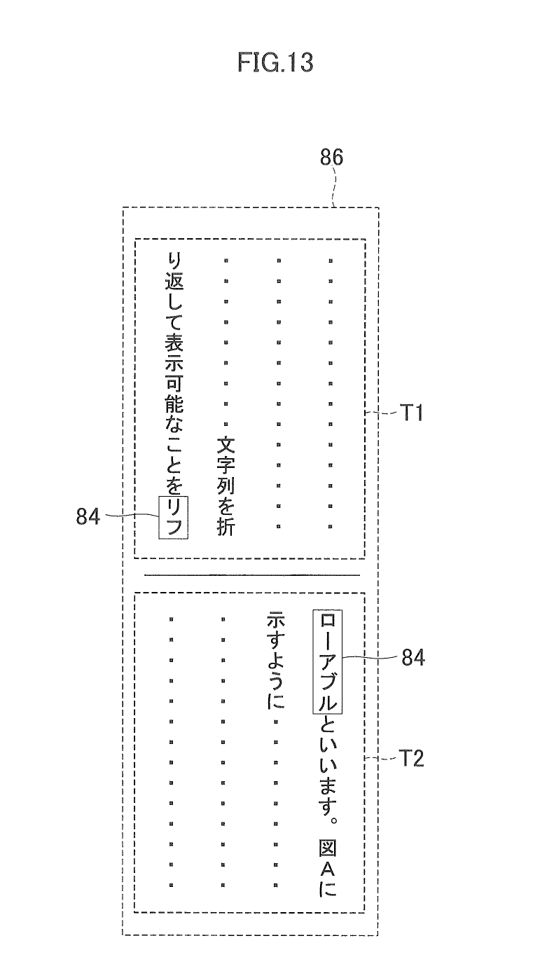

A portion denoted by a reference numeral 86 in the page image 51 of FIG. 12 is enlarged and depicted in FIG. 13. In this example, “reflowable” is inputted by the operation unit 42 as a search word. The search word “reflowable” in the character area is subjected to highlight display under the control of the control unit 41. In this highlight display, when the search word goes across different character areas T1 and T2, the control unit 41 highlight-displays characters “reflow” in the character area T1 and characters “able” in the character area T2 based on the additional information (such as the character position information 55 and the reading-order information 53) associated with the page image 51. That is, based on the additional information of the page image 51, the search word across a plurality of character areas is subjected to highlight display by following the reading order of the character areas.

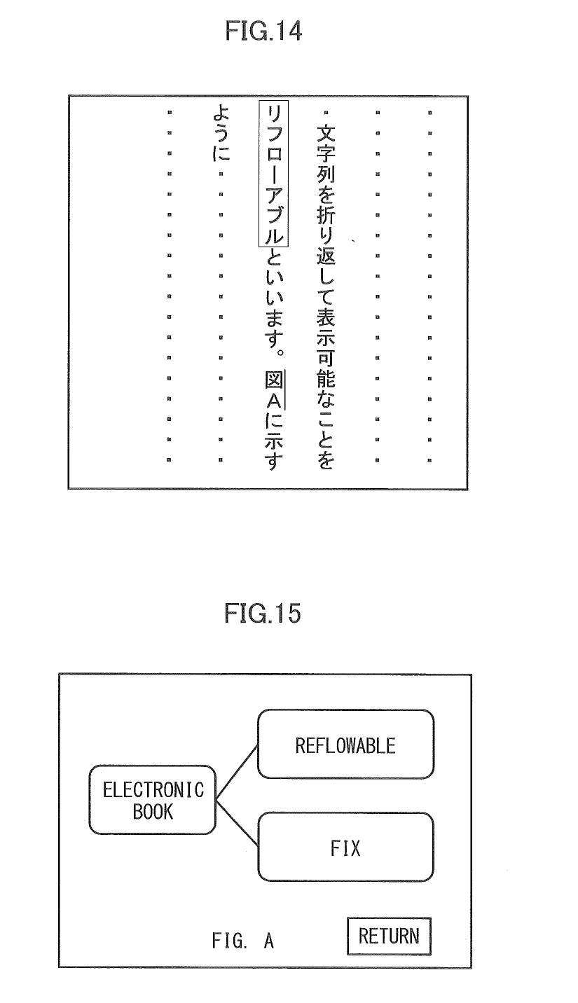

Also, when an instruction for switching between full display and reflow display is inputted by the operation unit 42, the full display depicted in FIG. 12 is switched to reflow display depicted in FIG. 14 under the control of the control unit 41. In the character strings of FIG. 14, “Fig. A” is a number of a diagram/table image in a non-character area, and a hyperlink to the diagram/table image (Fig. A) is set to this “Fig. A”. When “Fig. A” is touched with the operation unit 42, the image of Fig. A in the non-character area is displayed as depicted in FIG. 15.

In the above-described embodiment, description is exemplarily made to the case in which the electronic book production apparatus 2 has the display control program generating unit 220 and the display control program 59 is incorporated into the electronic book data 60. However, the present invention is not restricted to this example. The viewer device 4 may have the search function capable of searching for a character string across character areas in the page image based on the information added to the page image 51 in the electronic book data 60 and the highlight display function capable of highlighting the character string across the character areas found by searching. Also, the viewer device 4 may have a function capable of switching by the viewer device 4 between the display mode (the first display mode) of full display for displaying the page image without changing the arrangement of character areas, non-character areas, and characters in the character areas and the display mode (the second display mode) of reflow display by changing the arrangement of the characters in the character areas.

The present invention is not restricted to the examples described herein and the examples depicted in the drawings and, needless to say, various design changes and improvements can be made within a range not deviating from the gist of the present invention.

What is claimed is:

1. An electronic book production apparatus comprising;
an image obtaining unit which obtains a page image representing an image per page unit where character areas and non-character areas are arranged;
a character area detecting unit which detects the character areas in the page image obtained by the image obtaining unit;
a character recognizing unit which recognizes characters in the character areas detected by the character area detecting unit;
a character position information obtaining unit which obtains, for each of the characters recognized in the character areas, character position information indicating a position of the recognized character in the page image;
a reading-order determining unit which determines a reading order among the character areas in the page image based on positions of the character areas in the page image and continuity from a character to another character between the character areas in the page image;
an electronic book data generating unit which generates electronic book data including character information indicating the recognized characters, the character position information indicating the position of each of the recognized characters in the page image, and order information about the characters or the character areas corresponding to the reading order among the character areas in the page image; and
an electronic book data output unit which outputs the electronic book data generated by the electronic book data generating unit.

2. The electronic book production apparatus according to claim 1, further comprising a display control program generating unit which generates a display control program to be executed by a viewer device capable of displaying the page image, the display control program having a search function capable of searching for a character string in any of the character areas and a character string across character areas in the page image and a display function capable of highlighting the character string found by the search, based on information added to the page image in the electronic book data, wherein
the electronic book data generating unit incorporates the display control program into the electronic book data.

3. The electronic book production apparatus according to claim 2, wherein
the display control program generating unit generates the display control program that has a function of switching by the viewer device between a first display mode of displaying the page image without changing an arrangement of the character areas, the non-character areas, and the characters in the character areas and a second display mode of reflow display of the characters in the character areas.

4. The electronic book production apparatus according to claim 1, wherein
the reading-order determining unit preliminarily determines a reading order among the character areas based on the positions of the character areas in the page image, and corrects the reading order among the character areas in the page image based on the continuity from one character to another character between the character areas in the page image.

5. The electronic book production apparatus according to claim 1, further comprising a table-of-contents information generating unit which generates table-of-contents information indicating a correspondence between a title and a page number for every page or every plurality of pages for the page image, wherein
the electronic book data generating unit incorporates the table-of-contents information into the electronic book data.

6. The electronic book production apparatus according to claim 1, further comprising an index information generating unit which generates index information indicating a correspondence between a character string in the character area in the page image and a page number, wherein
the electronic book data generating unit incorporates the index information into the electronic book data.

7. The electronic book production apparatus according to claim 1, further comprising an anchor setting unit which sets, to a character indicating a partial image in any of the non-character areas among the characters in the character areas in the page image, an anchor for switching display to the partial image in the non-character area.

8. The electronic book production apparatus according to claim 1, further comprising a translation information generating unit which generates translation information obtained by translating character information indicating the characters recognized by the character recognizing unit into a language different from a language of the character information, wherein
the electronic book data generating unit incorporates the translation information into the electronic book data.

9. An electronic book system including the electronic book production apparatus according to claim 1 and a viewer device which obtains the electronic book data outputted from the electronic book production apparatus and displays the page image in the electronic book data.

10. The electronic book system according to claim 9, wherein the viewer device has a search function capable of searching for a character string in any of the character areas and a character string across character areas in the page image and a display function capable of highlighting the character string found by the search, based on information added to the page image in the electronic book data.

11. The electronic book system according to claim 9, wherein the viewer device has a function of switching by the viewer device between a first display mode of displaying the page image without changing an arrangement of the character areas and the non-character areas and an arrangement of the characters in the character areas and a second display mode of reflow display by changing the arrangement of the characters in the character areas.

12. An electronic book production method comprising:
an image obtaining step of obtaining a page image representing an image per page unit where character areas and non-character areas are arranged;
a character area detecting step of detecting the character areas in the page image obtained in the image obtaining step;
a character recognizing step of recognizing characters in the character areas detected in the character area detecting step;
a character position information obtaining step of obtaining, for each of the characters recognized in the character areas, character position information indicating a position of the recognized character in the page image;
a reading-order determining step of determining a reading order among the character areas in the page image based on positions of the character areas in the page image and continuity from character to character between the character areas in the page image;
an electronic book data generating step of generating electronic book data including character information indicating the recognized characters, the character position information indicating the position of each of the recognized characters in the page image, and order information about the characters or the character areas corresponding to the reading order among the character areas in the page image; and
an electronic book data output step of outputting the electronic book data generated in the electronic book data generating step.

13. A non-transitory computer-readable medium storing a program causing a computer to perform steps comprising:
an image obtaining step of obtaining a page image representing an image per page unit where character areas and non-character areas are arranged;
a character area detecting step of detecting the character areas in the page image obtained in the image obtaining step;
a character recognizing step of recognizing characters in the character areas detected in the character area detecting step;
a character position information obtaining step of obtaining, for each of the characters recognized in the character areas, character position information indicating a position of the recognized character in the page image;
a reading-order determining step of determining a reading order among the character areas in the page image based on positions of the character areas in the page image and continuity from character to character between the character areas in the page image;
an electronic book data generating step of generating electronic book data including character information indicating the recognized characters, the character position information indicating the position of each of the recognized characters in the page image, and order information about the characters or the character areas corresponding to the reading order among the character areas in the page image; and
an electronic book data output step of outputting the electronic book data generated in the electronic book data generating step.
